(19) United States
(12) Patent Application Publication
(10) Pub. No.: US 2010/0282419 A1
(43) Pub. Date: Nov. 11, 2010

(54) METHOD AND APPARATUS FOR ASSEMBLING DRAPERY

(75) Inventor: MICHAEL A LIGAS, SR., BARBERTON, OH (US)

Correspondence Address: Emerson, Thomson & Bennett, LLC, 1914 Akron-Peninsula Road, Akron, OH, 44313, US

(73) Assignee: MERLIN MANUFACTURING, INC., BARBERTON, OH (US)

(21) Appl. No.: 12/435,841

(22) Filed: May 5, 2009

(51) Int. Cl. E06B 9/24; E06B 9/00

(52) U.S. Cl. 160/84.01; 29/428

(57) ABSTRACT

A method of assembling a blackout drapery includes providing a textile material having an inner surface and an external surface, wherein the material has a first and second vertical edge and a first and second horizontal edge, covering the inner surface with a substantially light impermeable barrier, and folding at least one of the vertical edges inwardly along the length of the vertical edge, wherein the fold is not stitched.

### I. BACKGROUND

This invention pertains to the art of methods related to assembling draperies, and more particularly to assembling blackout for draperies.

Conventional draperies are primarily designed for style and appearance, and are generally made from premium fabrics of various colors. While such fabrics may serve the purpose of creating a desired visual effect, and may provide a desired level of privacy, they are generally ineffective for preventing a substantial quantity of light penetration into a room from outside sources, and a corresponding illumination of the room to an undesired level.

Accordingly, complete elimination of undesired light is a desirable goal. To achieve this result, blackout draperies and blackout drapery linings are typically used by hotels and motels in order to ensure that guest rooms can be maintained substantially dark at all times of the day. Residential use of blackout draperies is also desirable for those living in densely populated urban or suburban areas where the amount of light penetration into a bedroom at night may be considerable due to sources such as street lights, light from adjacent buildings and automobile headlights. Blackout draperies or drapery linings are generally made of a woven textile substrate, or of inexpensive non-woven substrates. The substrate is also coated with one or more layers of an acrylic latex based compound or foam, treated with resins such as water repellent, with an adhesive compound, or with fire-retardant materials, or with selected combinations. If the drapery or lining is to be used to blackout a room, at least one opaque layer is applied to the substrate. The opaque layer may be created by mixing an acrylic with a black pigment such as carbon black to provide the blackout effect. The blackout coating is applied over one surface of the textile substrate. Thus, the typical blackout drapery liner includes a textile substrate on one outer surface and the layer(s) of acrylic foam on the other outer surface.

The typical blackout drapery liner described above sufficiently prevents the penetration of external light; however, the exposure of the acrylic foam layers on the external surface thereof does not produce a durable and long-wearing product. The foam layers over time tend to abrade and may delaminate after repeated washing and/or dry cleaning. So called “pin holes” may also form in the liner due to a defect in the processing caused by small air bubbles in the acrylic foam layer. These air bubbles tend to rupture during manufacturing, causing “pin holes” to form in the liner, and thereby causing a degradation of the blackout effect. The external light penetrates the pin holes in the liner and creates a “sparkling” effect into the room itself or onto the opposed face of the drapery material. It is therefore desired to overcome the deficiencies of abrasion and degraded blackout effect generally encountered in the use of blackout drapery liners.

Blackout lining is beneficial when it comes to one aspect of commercial window coverings: light control. Blackout drapery linings essentially cut off all outside light. Blackout liners typically start with a base cloth, usually a poly/cotton blend. Then they are given either a two- or three-pass of aerocellular acrylic foam, one of which is an opaque layer. A three-pass liner will appear white on the cloth side, so it can be made up as a stand-alone drapery liner. The two-pass blackout eliminates the first coating so that the opaque layer goes directly onto the face cloth. That gives the fabric a gray look to that side. What enables blackout lining to control light so thoroughly is the opaque layer. Both two- and three-pass blackout linings have the same opacity. That is, they block out light equally well.

### II. SUMMARY

According to one embodiment of this invention, a method of assembling a blackout drapery includes providing a textile material having an inner surface and an external surface, wherein the material has a first and second vertical edge and a first and second horizontal edge, covering the inner surface with a substantially light impermeable barrier, and folding at least one of the vertical edges inwardly along the length of the vertical edge, wherein the fold is not stitched.

According to another embodiment of this invention, a blackout drapery includes a textile material having an inner surface and an external surface, wherein the material has a first and second vertical edge and a first and second horizontal edge, wherein the material is substantially light impermeable and at least one fold along at least one of the vertical edges, wherein the fold is along the length of the vertical edge, wherein the fold is not stitched.

Still other benefits and advantages of the invention will become apparent to those skilled in the art to which it pertains upon a reading and understanding of the following detailed specification.

### III. DEFINITIONS

Blackout drapery±any opaque material used to block out a substantial portion of light and/or sound, used as a covering for windows or other enclosures. The terms blackout drapery, blackout liner, and blackout curtain will be used interchangeably.

Curtain—a hanging screen usually capable of being drawn back or up. The terms curtain and drapery will be used interchangeably.

Hem—a border of a cloth article doubled back and stitched down.

Light Impermeable—prevention of approximately 100% of the light from passing through.

Serge—sews over the edge of one or two pieces of cloth for edging, hemming, or seaming. Synonymous with overstitch.

Stitch—one in-and-out movement of a threaded needle in sewing, embroidering, or suturing; a portion of thread left in the material after one stitch; to fasten, join, or close with or as if with stitches.

### IV. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a blackout drapery;

FIG. 2 is a perspective view of the drapery with one fold;

FIG. 3 is a perspective view of the drapery with two folds; and,

FIG. 4 is a perspective view of a drapery.

### V. DETAILED DESCRIPTION

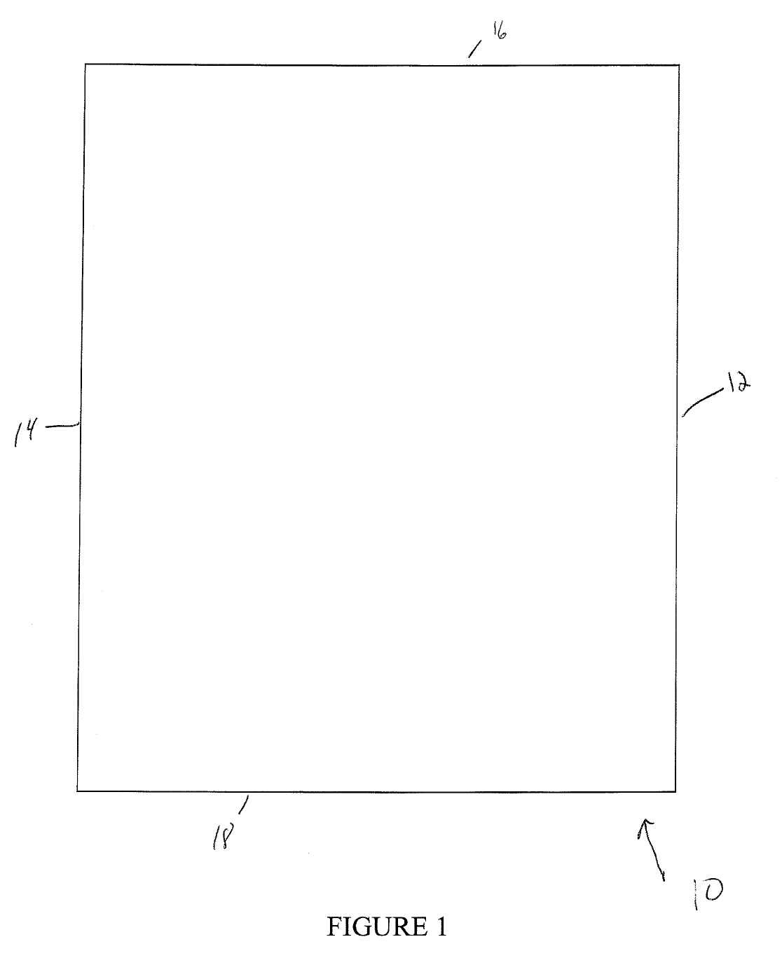

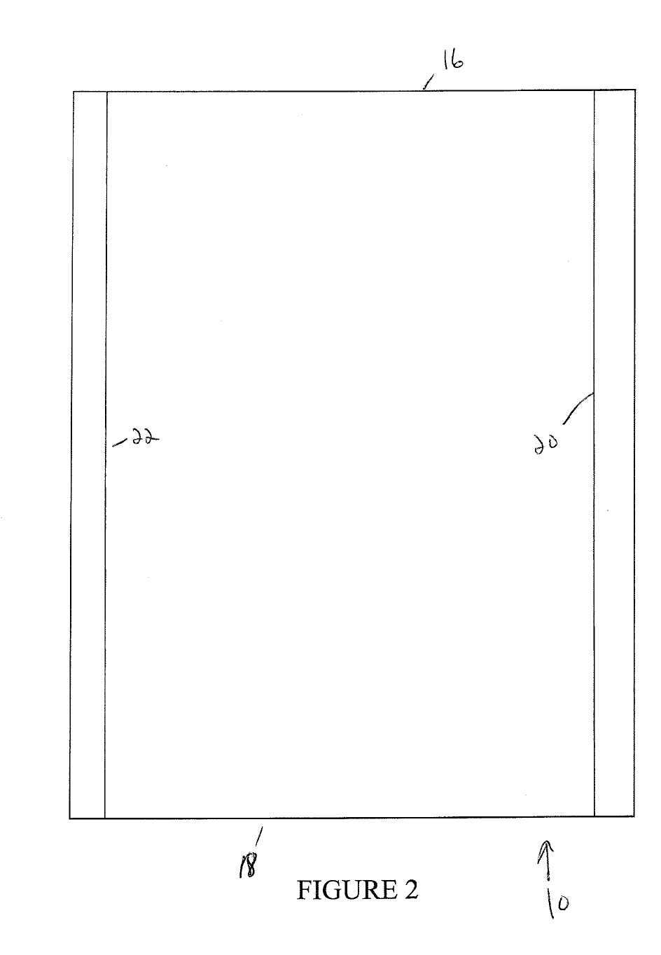

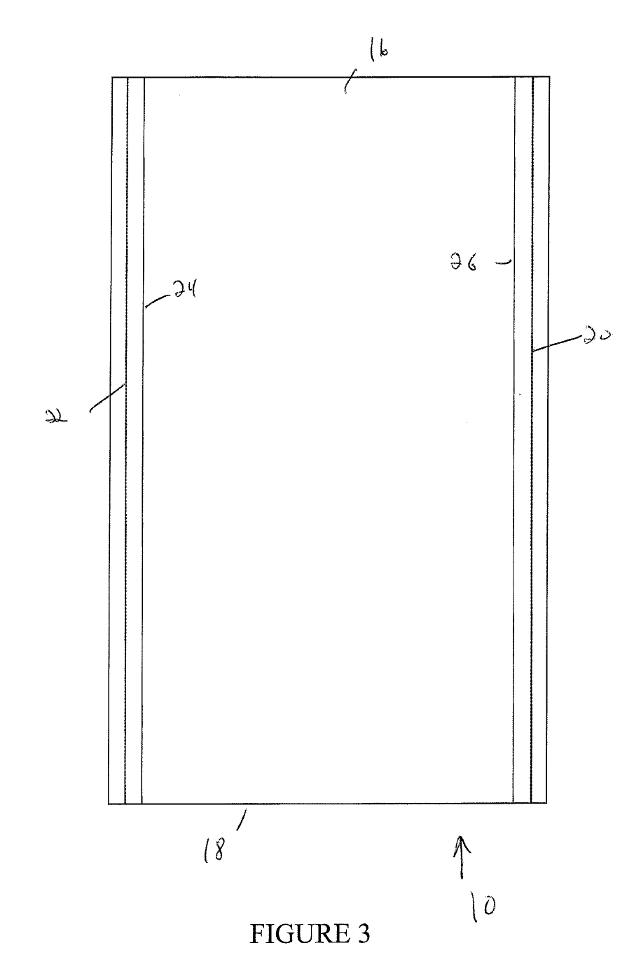

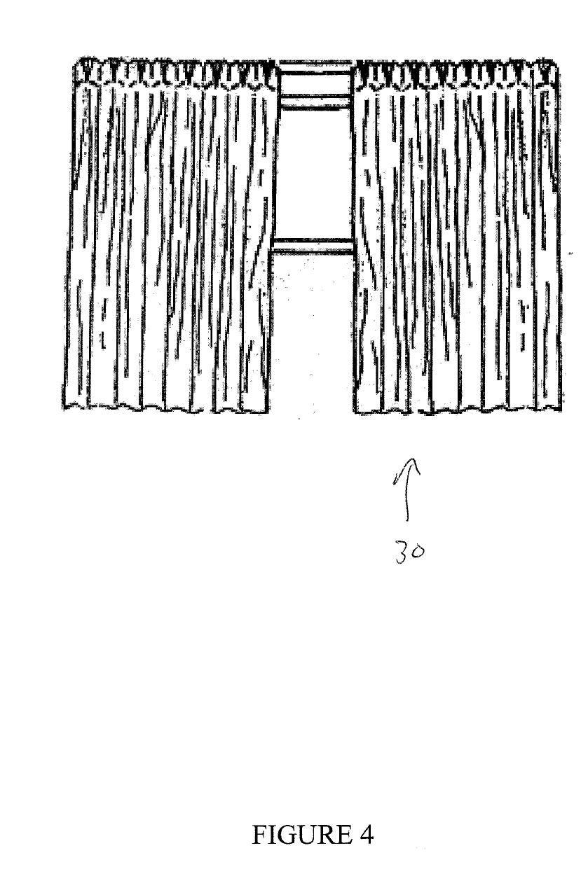

Referring now to the drawings wherein the showings are for purposes of illustrating embodiments of the invention only and not for purposes of limiting the same, and wherein like reference numerals are understood to refer to like components, FIGS. 1-4 show a blackout drapery 10, which has first and second vertical edges 12, 14 and first and second horizontal edges 16, 18. A curtain 30 is also shown, to which the blackout drapery 10 can be attached. The top of the drapery 10 is serged and the bottom of the drapery 10 is also serged. The top of the drapery can then be pleated. In one embodiment, the drapery 10 is serged along at least one of the vertical edges 12, 14, and then folded inwardly toward the center of the drapery 10. It is to be understood, however, that the drapery may not have a serge edge. The internal vertical edge 20 is shown in FIG. 2. In one embodiment, both edges 12, 14 are folded and create internal vertical edges 20, 22. It is to be understood that the distance that the internal vertical edges 20, 22 is folded inwardly is not a limiting factor, but can be any amount chosen using sound engineering judgment. The fold over edge allows the elimination of light through pin holes created by stitching, and does not require an additional layer. In this embodiment, the drapery 10 is not hemmed.

With continuing reference to FIGS. 1-4, in one embodiment, a serge edge is sewn at the internal vertical edges 20, 22 prior to folding. Once the folding occurs, the drapery 10 is then pressed in order to keep the drapery 10 from unfolding. The serge edge helps create a seal to further prevent the admission of light or sound. It is to be understood, however, that the invention does not require the use of a serge edge.

With continuing reference to FIGS. 1-4, in one embodiment the first fold is folded over itself at least one more time, which creates additional prevention of the admission of light and sound. The second fold 24 or second folds 24, 26 are then pressed as before to help stabilize the folds 24, 26. As with the previous folds, the distance inwardly to which the folds 24, 26 reach is not a limitation to this embodiment, but can be any distance chosen using sound engineering judgment.

With continuing reference to FIGS. 1-4, in one embodiment, the drapery 10 can have as many fold iterations as desired, and is only limited by sound engineering and business judgment.

With continuing reference to FIGS. 1-4, once the drapery 10 is folded, the drapery 10 can be attached to the curtain 30. The attachment of the drapery 10 to the curtain 30 is well known in the industry and will not be further described herein.

In one embodiment, the bottom of the drapery is folded upwardly between approximately one-half and four inches (including, without limitation, ½, ¾, 1, 1¼, 1½, 1¾, 2, 2¼, 2½, 2¾, 3, 3¼, 3½, 3¾, and 4 inches), although any fold distance can be chosen, as long as chosen using sound engineering judgment. In one embodiment the folds along the vertical edge have a total fold distance between approximately one inch and two inches (including, without limitation 1, 1¼, 1½, 1¾, and 2 inches).

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Other than in the operating examples, or where otherwise indicated, all numbers expressing quantities of ingredients, reaction conditions, and so forth used in the specification and claims are to be understood as being modified in all instances by the terms “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Having thus described the invention, it is now claimed:

1. A method of assembling a blackout drapery, the method comprising the steps of:
providing a textile material having an inner surface and an external surface, wherein the material has a first and second vertical edge and a first and second horizontal edge, wherein the material is substantially light impermeable; and,
folding at least one vertical edge inwardly along the length of the at least one vertical edge, wherein the fold is not stitched.

2. The method of claim 1, wherein the method further comprises the step of:
pressing the fold.

3. The method of claim 2, wherein prior to folding at least one vertical edge the method further comprises the step of:
sewing a serge edge along at least one of the vertical edges.

4. The method of claim 1, wherein after folding at least one vertical edge inwardly, thereby creating a first internal vertical edge, the method further comprises the step of:
folding the first internal vertical edge inwardly along the length of the first internal vertical edge.

5. The method of claim 4, wherein the method further comprises the step of:
pressing the fold creating by folding the first internal vertical edge.

6. The method of claim 4, wherein after folding the first internal vertical edge inwardly, the method further comprises the step of:
repeating the step of claim 4 at least one more time.

7. A method of assembling a blackout drapery, the method comprising the steps of:
providing a textile material having an inner surface and an external surface, wherein the material has a first and second vertical edge and a first and second horizontal edge;
covering the inner surface with a substantially light impermeable barrier; and,
folding at least one of the vertical edges inwardly along the length of the vertical edge, wherein the fold is not stitched.

8. The method of claim 7, wherein the method further comprises the step of:
pressing the fold.

9. The method of claim 8, wherein prior to folding at least one vertical edge the method further comprises the step of:
sewing a serge edge along at least one of the vertical edges.

10. The method of claim 7, wherein after folding at least one vertical edge inwardly, thereby creating a first internal vertical edge, the method further comprises the step of:
folding the first internal vertical edge inwardly along the length of the first internal vertical edge.

11. The method of claim 10, wherein the method further comprises the step of:
pressing the fold creating by folding the first internal vertical edge.

12. The method of claim 10, wherein the method further comprises the step of:
sewing a serge edge along an outside edge created by the fold.

13. The method of claim 10, wherein after folding the first internal vertical edge inwardly, the method further comprises the step of:
repeating the step of claim 10 at least one more time.

14. The method of claim 13, wherein the method further comprises the step of:
pressing the folds.

15. A blackout drapery, the drapery comprising:
a textile material having an inner surface and an external surface, wherein the material has a first and second vertical edge and a first and second horizontal edge, wherein the material is substantially light impermeable; and,
at least one fold along at least one of the vertical edges, wherein the fold is along the length of the vertical edge, wherein the fold is not stitched.

16. The drapery of claim 15, wherein the fold has been pressed.

17. The drapery of claim 15, wherein the drapery further comprises:
a serge edge along at least one of the vertical edges.

18. The drapery of claim 15, wherein the drapery further comprises:
at least a second fold, wherein the at least a second fold is folded inwardly from the at least one fold.

19. The drapery of claim 18, wherein the fold is pressed.

20. The drapery of claim 19, wherein the drapery further comprises:
a serge edge along an outside edge created by the fold.
